(19) United States
(12) Patent Application Publication
(10) Pub. No.: US 2011/0300375 A1
(43) Pub. Date: Dec. 8, 2011

(54) Comminution of ultra-high molecular weight polyethylene fibers

(75) Inventor: Heinrich Derenowski, Leichlingen (DE)

(73) Assignee: HD KUNSTDTOFFE & KUNSTSTOFFERZEUGNISSE GMBH, Burscheid (DE)

(21) Appl. No.: 13/151,046

(22) Filed: Jun. 1, 2011

(30) Foreign Application Priority Data
Jun. 2, 2010 (DE) 10 2010 029 633.3

(51) Int. Cl. B32B 5/16; C08F 110/02; B02C 19/00; B32B 27/02; B32B 27/32

(52) U.S. Cl. 428/338; 428/401; 241/30; 526/352

(57) ABSTRACT

The invention pertains to a process for processing fibers of polyethylene having a molecular weight Mw of at least 10.000.000 g/mol and the use of the so-obtained fiber pieces.

### FIELD OF THE INVENTION

The invention pertains to a process for comminuting fibers of polyethylene having a molecular weight Mw of at least 10,000,000 g/mol and the use of the so-obtained fiber pieces.

### RELATED APPLICATIONS

The present Application claims the benefit under 35 U.S.C. §119 of the Jun. 2, 2010 filing date of German Patent Application DE 10 2010 029 633.3, the entirety of which Application is incorporate herein by reference.

### BACKGROUND OF THE INVENTION

It has been known to produce polyethylene fibers from UHMWPE (ultra-high molecular weight polyethylene, also abbreviated as HMPE, HPPE or UHMW) by gel spinning (see e.g., US2007/0148452A1). Usually UHMWPE has a molecular weight Mw in a range of from 2 to 6×10⁶ g/mo. (cf. http://en.wikipedia.org/wiki/Ultra_high_molecular_weight_polyethylene). Conventional UHMWPE is still machinable (see e.g., DE69525924T2, WO2008/097170A1, DE69737356T2, DE69028519T12 or DE69631076T2). However, in this process even UHMWPE having a molecular weight Mw of significantly below 6×10⁶ g/mol often initially has to be radioactively irradiated or thermally treated such that the polymer decomposes in order to reduce the molecular weight and to render the polymer machinable at all. Usually, depending on its quality UHMWPE has a melting point between 125 and 145° C. It has been known that UHMWPE thermally decomposes at distinctly lower temperatures, e.g., at temperatures of 120° C. and higher and its molecular weight decreases.

Up to the present, UHMWPE having a molecular weight Mw exceeding 8×10⁶ g/mol cannot be machined and is practically obtainable only as a fiber (see, e.g., WO2009/077168A2, WO2005/066401A1 or WO2010/057982A1). Fibers having molecular weights Mw up to 16×10⁶ g/mol are well-known (see, e.g., D. M. REIN et al. “Electrospinning of Ultrahigh-Molecular-Weight Polyethylene Nanofibers”, Journal of Polymer Science: Part B: Polymer Physics, 2007, 766).

Up to the present, prior art does not disclose any method for reducing (comminuting) UHMWPE having a molecular weight MW of at least 10,000,000 g/mol to small pieces in economically significant amounts. Hence, up to now a corresponding UHMWPE in forms other than fibers is not known. In particular, many molders require starting material in the form of bulk material which has not yet been available with such a high molecular weight.

Accordingly, it is the object of the present invention to give the known fibers having a molecular weight of at least 10,000,000 a shape which can be better processed by the plastics processing industry without suffering an excessive decrease of the molecular weight.

### BRIEF DESCRIPTION OF THE DRAWING

The drawing is a photograph of a device capable of performing the comminuting process of the present invention.

### DETAILED DESCRIPTION OF THE INVENTION

In a first embodiment the object of the present invention is achieved by a process for processing fibers of polyethylene having a molecular weight Mw of at least 10,000,000 g/mol, characterized in that the fibers are cut up and fixed during the dividing operation.

Up to the present, polymer fibers or polymer strands emerging from an extruder have been cut with a blade without stopping the feed motion of the fibers or strands during the cutting operation. For example, in the manufacture of plastic pellets the polymer strands continuously emerging from the dies of the extruder are cut off with a rotating knife. Up to now, there was no need to stop the fibers or the extrudate during the cutting operation. Moreover, there has been the prejudice that stopping the material to be cut during the cutting operation is uneconomical.

Surprisingly, now it has been found that fibers having a molecular weight of at least 10,000,000 g/mol that have previously been known to be resistant to cutting to small fiber pieces (i.e. resistant to being comminuted) can be cut, for example, if the advance of the fibers during the cutting operation is stopped and the fiber is fixed at the cutting edge. Contrary to previous methods, in this way even reducing said high-molecular fibers to small pieces (i.e. comminuting them) without significant deterioration of material properties and with high throughput is possible. The drawback resulting from not fixing the fibers during the dividing operation is that the cutting device will excessively heat up after a certain material throughput, thus preventing a reduction to small pieces to an economically attractive extent. To date, the reason of this heating can only be assumed. The prior art has not yet solved this problem.

In another embodiment the object of the present invention has been achieved by a process for processing (comminuting) fibers of polyethylene having a molecular weight Mw of at least 10,000,000 g/mol, characterized in that the fibers are divided (cut) with a blade and the cutting edge of the blade is moved relative to the fiber also in a direction differing from the cutting direction by at least 20° during the dividing operation.

To date, polymer fibers have been cut with blades which perpendicularly impact the fibers. For example, also in the manufacture of pellets a rotating knife with a straight blade impacts the extruded polymer strands emerging from the dies of the extruder. Polymer fibers are also ground in mills. In this process a mill having a cutting edge on a roller is often used, said cutting edge being straight and arranged exactly parallel to a stationary cutting edge next to the roller and forming a cutting gap therewith. When attempting to cut polyethylene fibers having a molecular weight Mw of at least 10,000,000 in such a conventional way, on the one hand it was not possible to cut said fibers with most blade materials at all and on the other hand a large evolution of heat occurred. In an experiment a traditional mill for reducing polymer fibers to small pieces comprising a straight cutting edge failed already within a short time.

Surprisingly, it has now been found that during the dividing (comminuting) operation the cutting edge of the blade can be moved relative to the fiber also in a direction differing from the cutting direction by at least 20° and thus substantially less heat is generated at high material throughputs.

If the fibers are fixed during the cutting operation of the process according to the invention, they can advantageously be divided with a blade and the cutting edge of the blade can advantageously be moved relative to the fiber also in a direction differing from the cutting direction by at least 20°.

If, in the process according to the invention, the fibers are divided with a blade and the cutting edge of the blade is moved relative to the fiber also in a direction differing from the cutting direction by at least 20° during the dividing operation, the fibers can advantageously be cut up and fixed during the cutting operation.

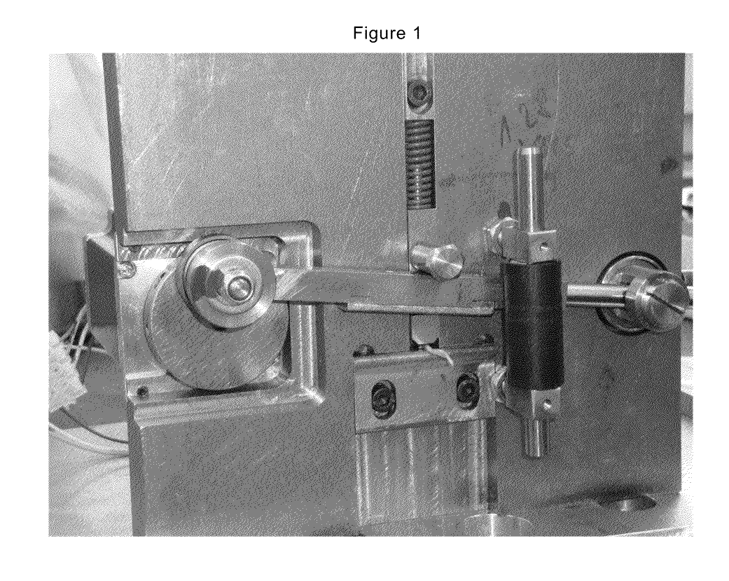

During the dividing (comminuting) operation the cutting edge of the blade can preferably be moved relative to the fiber in a direction differing from the cutting direction by at least 20° such that the cutting edge of the blade is oriented in the same direction as the bend of the fiber (e.g., by use of a crescent-shaped blade) or, e.g., the cutting edge of the blade is pressed through the fiber not only in the cutting direction but additionally also moved back and forth in a direction deviating therefrom (see FIG. 1).

The fibers are preferably cut using a drawing cut. The cutting movement is preferably effected obliquely with respect to the tool.

If a mill with a roller is used, e.g., the cutting edge of the roller can be arranged not in a straight, but in a curved manner, in particular like a helix, around the roller. For example, the cutting edge of the blade can be moved in a direction differing from at least 45° and up to 135° from the cutting direction. When using a mill for dividing the fibers, the fibers are preferably ground to a product having a wool- or wadding-like appearance. This is advantageous in that said wadding- or wool-like material can easily be agglomerated in a commercial agglomerator (e.g., a Pallmann Agglomerator Typ PVF 120). When using a mill, said mill is preferably not, as usual, operated with speeds in a range of from 8,000 to 16,000 revolutions per minute, but the roller speed is adjusted to a speed in a range of from 1,000 to 5,000 revolutions per minute.

The material at least of the cutting edge can preferably be selected from the group consisting of ceramics, diamond-coated metal or nitrided metal. It has been observed that this resulted in a distinctly lower temperature rise during cutting or dividing and a higher material throughput could be realized this manner.

In the process according to the invention the amount of processed fibers is preferably adjusted such that the temperature does not exceed 100° C., in particular 60° C. during the separating or dividing (comminuting) operation. This ensures that the material properties of the fibers will not change. Namely, it has been observed that the molecular weight and thus properties such as the cut resistance of the fibers may deteriorate above this temperature.

The fibers are preferably divided into pieces having a length in a range of 0.01 to 100 mm, in particular of 0.1 to 60 mm, very particularly preferably of at most 1 mm. Below this range the manufacture of fiber pieces is no longer economical. Above this range later processing is difficult. Preferably polyethylene fibers having a molecular weight Mw of at least 20,000,000 g/mol are used. Preferably polyethylene fibers having a filament diameter in a range of from 2 to 50 μm are used.

The cutting tools or cutting mills can be cooled, e.g., by internal cooling. Alternatively or additionally the yarn or fiber strand can also be cooled with air. Preferably the cooling air is also used for discharging the cut material.

In another embodiment the object of the present invention is achieved by fiber pieces produced by a process according to the invention, characterized in that 90% of the fiber pieces have a length in a range of from 0.1 to 100 mm.

In another embodiment the present invention provides an agglomerate obtained by agglomerating the fiber pieces according to the invention. A commercial agglomerator (e.g., a Pallmann Agglomerator Typ PVF 120) can be used for this purpose. During agglomeration preferably a temperature of less than 120° C., in particular less than 100° C. is adjusted in order to avoid decomposition of the material and a potential decrease of the molecular weight as far as possible. For example, the agglomerator container can be cooled (e.g., with nitrogen, air or water).

In another embodiment the present invention provides a powder obtained by grinding the agglomerate according to the invention and/or the fiber pieces according to the invention. During grinding preferably a temperature of less than 120° C., in particular less than 100° C. is adjusted in order to avoid decomposition of the material and a potential decrease of the molecular weight as far as possible. The mean particle size (determined, e.g., by sieving) of the powder is preferably in a range of from 10 to 2000 μm. For example, grinding can be performed with a commercial impact disk mill. If required, the mill can be cooled with liquid nitrogen.

In another embodiment the present invention provides a shaped piece (a shaped article) predominantly made of polyethylene having a molecular weight Mw of at least 10,000,000 g/mol obtained by

a. compacting the fiber pieces according to the invention and/or the agglomerate according to the invention,
b. subsequently producing a mixture containing at least from 5 to 20% by volume of an adhesion promoter and from 80 to 95% by volume of compacted fibers or compacted agglomerate and
c. subsequently press-molding (i.e. compression molding) the mixture to form a shaped piece (article).

The adhesion promoter can be selected from commercial adhesion promoters such as, e.g., epoxy resin.

The compression mold is preferably provided with a mold release agent such as, e.g., a film or a silicone coating. Press-molding is preferably performed at a temperature of at most 40° C., thus maintaining the material properties of the polyethylene.

In another embodiment the present invention provides a shaped piece (shaped article) predominantly made of polyethylene having a molecular weight Mw of at least 10,000,000 g/mol obtained by press-molding (compression molding) the fiber pieces according to the invention and/or the agglomerate according to the invention and/or the powder according to the invention, wherein a temperature in the range of from 120 to 250° C. is applied during molding for a period of from 0.5 to 5 h.

Preferably fiber pieces and/or the agglomerate according to the invention and/or the powder according to the invention having a molecular weight Mw of at least 20,000,000 g/mol are used in order to achieve a molecular weight of the shaped piece according to the invention despite a possible degradation during compressing. Preferably, the action of heat is restricted to a duration of up to 2 h in order to restrict decomposition to the minimum. Preferably, a temperature of at least 220° C. is used since it has surprisingly been found that a shorter treatment at a higher temperature resulted in a substantially lower decomposition of the material compared to a longer treatment at lower temperatures.

In another embodiment the object of the present invention is achieved by the use of the shaped piece according to the invention as underbody protection for vehicles or as armor plating or bullet-proof equipment of walls, persons, vehicles or buildings. In particular, walls of mobile structures such as, e.g., portable toilets can be equipped with the shaped pieces according to the invention.

### EXAMPLES

### Example 1

Dyneema® SK 78 fiber supplied by DSM company was divided into pieces using a device. One filament of said fiber has a diameter of approximately 20 μm. The yarn (fiber) to be unwound from a bobbin was fed via a feeding device to a transport and feeding device. The feeding roller provided with a transmission transports a length of fiber corresponding to the required cutting length to a hold-down device comprising steel jaws. A bundle of approximately 100 filaments was introduced in a gap between two steel jaws which can be moved towards each other and clamped between the steel jaws such that the filament bundle protruded by approximately 3 cm. The outer edges of the steel jaws had been hardened by plasma nitriding. Subsequently, a steel blade was lowered at the outside of the steel jaws such that the fibers were cut through. In doing so, the blade was also moved substantially perpendicular to the cutting direction. During the dividing operation the fibers were clamped so tightly that they did not move relative to the steel jaws. Subsequently, the gap between the steel jaws was opened and a length of fiber was again fed such that the fiber protruded by 3 cm. This process was repeated automatically until approximately 3 kg of fiber were processed. Subsequent to the dividing operation the fibers were directly collected by suction to avoid any unnecessary long thermal stress on the fibers.

### Example 2

Dyneema® SK 78 fiber supplied by DSM company was divided into pieces using a commercial cut converter for fibers with a cutting roller (e.g., supplied by Schlumberger; cf. Franz Fourné “Synthetische Fasern: Herstellung, Maschinen and Apparate, Eigenschaften”, Hanser Verlag, 1995, p. 583). However, the cutting roller was modified such that the cutting knife was not arranged along the main axis on the outer surface of the roller but around the roller in a helical manner. The cutting edge was made of plasma nitrided steel. The roller was operated with a rotational speed of about 3,000 revolutions per minute. A wool- or wadding-like product consisting of fiber pieces having different lengths was obtained, virtually all of them having lengths between 0.3 and 6 cm.

### Example 3

The cut fibers of example 1 or the ground/torn fibers of example 2 were fed to a commercial agglomerator, a Pallmann Agglomerator Typ PVF 120, and agglomerated using conventional parameters. In this step it was ensured that the temperature did not exceed 100° C. The obtained product was useful as bulk material.

### Example 4

The agglomerate of example 3 was ground to a powder having a mean particle size of approximately 1000 μm in a commercial impact disk mill. The obtained product was useful as bulk material.

### Example 5

Employing usual methods, the powder of example 4 was press-molded to a plate. During press-molding a temperature of 210° C. was adjusted for 1.5 h. After pressing, the plate was 1.5 cm thick. This plate resisted the impact of a NATO caliber (.308 Winchester) bullet. The molecular weight of the material still exceeded 10,000,000 g/mol.

### Example 6

The fiber pieces obtained in example 1 were compacted in a commercial compactor. The molecular weight of the material still exceeded 10,000,000 g/mol. Subsequently, a mixture of 12% by volume of the epoxy resin binder ASODUR®-SFE and 88% by volume of the compacted fiber pieces was prepared and subsequently compressed in the usual manner. The so-obtained shaped piece was removed. Throughout the process the material was not heated, hence, there was no degradation of the material.

1. (canceled)

2. A process for comminuting fibers of polyethylene having a molecular weight, Mw, of at least 10,000,000 g/mol, wherein the fibers are cut up with a blade having a cutting edge moved in a cutting direction and the cutting edge of the blade is also moved relative to the fiber in a direction differing from the cutting direction by at least 20° during the comminuting process.

3. (canceled)

4. The process according to claim 2, wherein the fibers are fixed when cut up during the comminuting process.

5. Fiber pieces produced by the process according to claim 2, wherein 90% of the fiber pieces have a length in a range of from 0.01 to 100 mm.

6. An agglomerate obtained by agglomerating the fiber pieces according to claim 5.

7. A powder obtained by milling the agglomerate according to claim 6, the fiber pieces according to claim 5, or a combination of them.

8. A shaped article, a majority of which comprises polyethylene having a molecular weight, Mw, of at least 10,000,000 g/mol, the shaped article obtained by a process comprising the steps of:
a. compacting the fiber pieces according to claim 5, the agglomerate according to claim 6, or a combination of them,
b. subsequently producing a mixture containing from 5 to 20% by volume of an adhesion promoter and from 80 to 95% by volume of compacted fiber pieces, compacted agglomerate, or combination thereof, and
c. subsequently compression molding the mixture to form the shaped article.

9. A shaped article, a majority of which is comprised of polyethylene having a molecular weight, Mw, of at least 10,000,000 g/mol obtained by press-molding the fiber pieces according to claim 5, the agglomerate according to claim 6, the powder according to claim 7, or a combination of any of them, wherein a temperature in a range of from 120 to 250° C. is applied during compression molding for a period of from 0.5 to 5 hours.

10. The shaped article according to claim 8 in the form of underbody protection for vehicles or as armor plating or bullet-proof equipment of walls, persons, vehicles or buildings.

11. The shaped article according to claim 9 in the form of underbody protection for vehicles or as armor plating or bullet-proof equipment of walls, persons, vehicles or buildings.

12. Fiber pieces produced by the process according to claim 4, wherein 90% of the fiber pieces have a length in a range of from 0.01 to 100 mm.
